(19) United States
(12) Patent Application Publication
(10) Pub. No.: US 2020/0257523 A1
(43) Pub. Date: Aug. 13, 2020

(54) APPLICATION FEATURE CHANGE DETECTION

(71) Applicant: International Business Machines Corporation, Armonk, NY (US)

(72) Inventors: Bharat B. Purohit, Pimple saudagar (IN); Prem Prakash, PUNE (IN); Ratnalikar Sarang Deepak, Pune (IN); Arun Ramakrishnan, Chennai (IN)

(21) Appl. No.: 16/272,887

(22) Filed: Feb. 11, 2019

(51) Int. Cl. G06F 8/71; G06F 16/84; H04L 29/08; H04L 29/06

(52) U.S. Cl. CPC G06F 8/71; H04L 63/1425; H04L 67/20; G06F 16/86

(57) ABSTRACT

According to a computer-implemented method, sections of an application program instruction set are marked with tags to associate the sections of the application program instruction set with different application features. A change made to a section of the application program instruction set is detected. Based on a tag, the change to the section of the application program instruction set is associated with a change to a respective application feature.

### BACKGROUND

The present invention relates to the detection of changes to application features, and more specifically to the identification of changes to the features based on changes to program instruction set sections that execute that feature. Application program instruction sets are relied on to execute any number of computing features. For example, a program instruction set may be generated for providing an expense analysis application.

### SUMMARY

According to an embodiment of the present invention, a computer-implemented method is described. According to the computer-implemented method, sections of an application program instruction set are marked with tags to associate sections of the application program instruction set with different application features. A change to a section of the application program instruction set is detected and, based on the tag, the change to the section of the application program instruction set is associated with change to a respective application feature.

The present specification also describes a computing system. The computing system includes a tagging device to mark sections of an application program instruction set with tags to associate sections of the application program instruction set with different application features. A database of the computing system maps tags to different application features. A change tracking device detects a change to a section of the application program instruction set and a mapping device associates, based on the database, the change to the section of the application program instruction set with a change to a respective application feature.

The present specification also describes a computer program product. The computer program product includes a computer readable storage medium having program instructions embodied therewith. The program instructions executable by a processor cause the processor to create tags related to different application features of an application program instruction set and to mark sections of an application program instruction set with tags to associate sections of the application program instruction set with different application features. The program instructions also cause the processor to receive, from a third-party, a subscription request to receive notifications of changes to a particular application feature. The program instructions also cause the processor to detect a change to a section of the application program instruction set associated with the particular application feature and identify the tag associated with a changed section of the application program instruction set. The program instructions also cause the processor to record a change to the particular application feature associated with the tag and provide notification to the third-party that the particular application feature is changed.

### BRIEF DESCRIPTION OF THE DRAWINGS

FIG. 1 depicts a flowchart of the method for detecting application feature changes, according to an example of the principles described herein.

FIG. 2 depicts a computing system for detecting application feature changes, according to an example of principles described herein.

FIG. 3 depicts a flowchart of the method for detecting application feature changes, according to another example of principles described herein.

FIG. 4 depicts a computing system for detecting application feature changes, according to another example of principles described herein.

FIG. 5 depicts a computer program product with a computer readable storage medium for detecting application feature changes, according to an example of principles described herein.

### DETAILED DESCRIPTION

The present invention may be a system, a method, and/or a computer program product any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per Sc, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Program instruction sets refer to the instructions that allow a computing device to execute a particular application. For example, a computing device may execute a spreadsheet application that allows a user to input data and to output graphs and charts that visualize that data. Accordingly, the spreadsheet application includes an application program instruction set. The application may include a number of functionalities. For example, one functionality of a spreadsheet application is the ability to graphically display the spreadsheet. Another example of a functionality of the spreadsheet is the ability to print the spreadsheet. Each functionality may have different features associated with it. For example, relating to the functionality of sending an email, a feature may be to embed an attachment, like an image, into the email. In other words, the functionality of an application refers to an option, or offering, of an application. The feature, by comparison, refers to the abilities the program instruction set enables for that functionality. Put yet another way, a functionality is an end-to-end set of operations controlled by an application that is made up of one or more features.

Given the prolific use of electronic devices in modern society, it is no stretch to suggest that development in this area will only increase as will the sophistication of applications executed on the electronic devices. That is, there is no reason to believe that computing device usage, nor the implementation of applications for use on such computing devices, is going to slow. However, the current application development process has certain inefficiencies, that if not addressed, may impede the further development and integration of beneficial applications.

Specifically, as an application instruction set grows and evolves, it may undergo several changes that have an impact on the behavior of the system. For example, additional functionalities may be added to an application, and that additional functionality may alter the operation of the application as a whole. At any given time, different entities along the development pipeline may have access to an application. For example, a developer may be making changes to a feature of a particular functionality. Simultaneously, a quality assurance user may be testing that feature or another feature of the application, all while being unaware of the developer's work. The lack of communication that may accompany these multi-user access may result in ineffective product development. That is, a developer may make a change to a feature that the quality assurance user is unaware of. Accordingly, the application may be awaiting testing by the quality assurance user, but the quality assurance user may be unaware of his task. In other words, aside from manual effort, there may be no way to keep all interested parties up to date on the details of changes that are made to the application program instruction set.

Put another way, an application has many functionalities. Over time, the functionality set may change. Changes to the features/functionalities of an application should be verified before being released to the public. Oftentimes these changes may be communicated via physical or digital documentation such as release notes. If, however, that documentation is not up to date, interested parties, be they customers, quality assurance users, or other stakeholders may be unaware of such changes. This may impact their ability to test/verify the application or in the case of a consumer, to properly use the application functionality.

The present specification addresses these, and other, issues, by automatically sending notifications to subscribing third parties if there is a change to a feature that they have indicated an interest in. For example, an application may have a number of functionalities such as spreadsheet printing, spreadsheet display, expense report breakdown etc. A developer may alter some aspects of a feature related to the expense report breakdown functionality. Such a change may require verification by the quality assurance user before release. Moreover, the expense report breakdown may affect how a spreadsheet is displayed and/or printed. Accordingly, the present specification, rather than relying on the developer passing word to the quality assurance user, which may or may not happen, generates a notice automatically that indicates to the quality assurance user that a feature of the expense report breakdown functionality has changed. In this fashion, the quality assurance user, or any other user, is on notice of the status of the application feature.

Specifically, the present specification provides a way of feature detection by detecting changes to a portion of the application program instruction set that relates to that feature. That is, the application program instruction set includes instructions to carry out a particular feature. As a developer changes those instructions, that change is carried through, and indicated to a third-party subscriber, as a change to the feature. This may be done by tagging the sections of the application program instruction set that relate to a particular feature and then to detect a change to the program instructions. The location in the instruction set that is changed is identified by the tag and the feature associated with that tag is identified and passed to any interested third-party subscribers.

The method, system, and computer program product of the present specification provide a number of benefits. For example, the method, system, and computer program product bridge the gap between developers, engineers, users, and other entities that use, work on, or consume the application. It increases productivity by making the development of a particular application program instruction set more transparent. The method, system, and computer program product reduce costs by reducing inefficiencies in the development process as all parties involved have more information at their fingertips by which they may complete their respective duties.

Moreover, the open communication regarding changes made to instruction sets can reduce the overall amount of instructions in the instruction set. That is, over time changes are made to a particular instruction set. In some cases, rather than repair a section of the instruction set, a developer may insert new instructions altogether. Thus, the instruction set has redundant instructions, which can affect the runtime execution of the application. Accordingly, by identifying sections of the program instructions by feature, rather than simply inserting new instructions, a developer can alter the instructions that already exist, in other words, the entire instruction set is less redundant, less bloated, and therefore has a faster runtime execution as compared to when such tag-based feature detection is not implemented.

As used in the present specification and in the appended claims, the term “a number of” or similar language is meant to be understood broadly as any positive number including 1 to infinity.

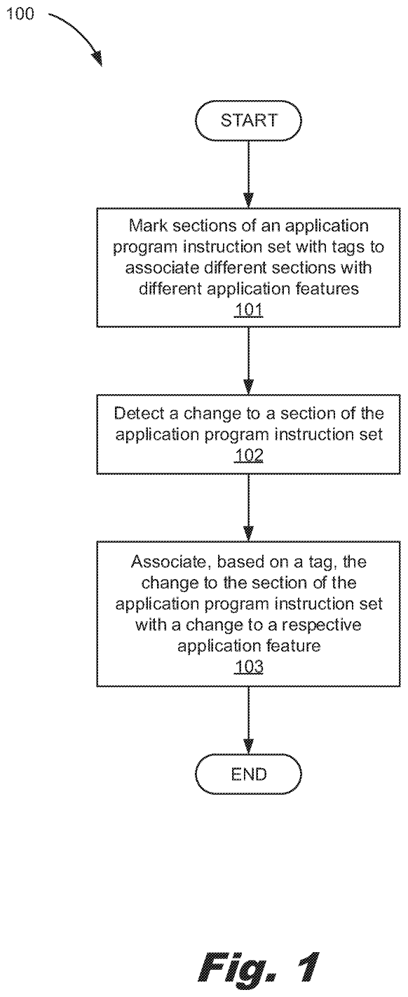

Turning now to the figures, FIG. 1 depicts a flowchart of the method (100) for detecting application feature changes, according to an example of the principles described herein. According to the method (100), sections of an application program instruction set are marked (block 101) with tags. The tags associate the different sections of the application program instruction set with different application features. That is, the program instruction set may include text, with different portions of the text used to execute different features of the application. For example, in a budgeting application, one functionality may be to track money spent on different categories. This functionality may include different features, such as a feature that displays a graph of money spent on different categories. Accordingly, a section of the application program instruction set may be the textual instructions that, when executed by a processor, displays the graph. Accordingly, this section of the application program instruction set may be marked (block 101) with a tag that associates it with the graphical display feature. In general, a tag refers to metadata that is associated with a portion of an instruction set. The tag may be searched and used to identify the associated data.

In this example, marking (block 101) the application program instruction set with tags may be performed by a user. That is, a developer of the application may, in any variety of ways, select a portion of the application program instruction set and may create a tag that identifies a feature associated with that portion. For example, a developer may generate an instruction set relating to the feature of converting data into a graphical display. In this example, the developer may create a tag “graph” and may associate it with the relevant sections of the application program instruction set.

Note that the tags used in the present method (100) are entirely customizable. That is, a developer or other user may create customized tags based on a particular application under development. These tags, as described above, associate sections of a text-based instruction set to the feature that they, when executed by the processor, provide to a user of the application. While specific reference is made to manual tagging via a developer at a user interface, in some examples such tagging may be automated. That is, a component of a computing device may, using any number of mechanisms such as a machine-learning system, can identify what feature a section of the application program instruction set provides, and may generate a tag and associate the tag with that section.

In some examples, a tag is associated with multiple sections of the application program instruction set. That is a feature may be used in various sections of the program instruction set. For example, the conversion of certain data into a graph may be implemented in 1) a printing functionality of the application and 2) a visualization functionality of the application.

Next, a change is detected (block 102) to a section of the application program instruction set. Such a detection (block 102) may be the result of a textual-based comparison of different versions of the application program instruction set. That is, as the instruction set includes textual instructions in a particular protocol/language, a textual comparison of the characters that make up the different versions can be made to identify any changes to the text therein. That is, in order to add or expand a feature, the text of the program instructions may be changed. A textual analysis tool may compare the two versions, i.e., pre- and post-change, with changes being flagged by the system.

The change to the section of the application program instruction set is then associated (block 103) to the respective application feature. That is, based on the tag, the change to the section of the application program instruction set is mapped to the respective application feature. As described above, tags are created which relate to particular features of a computing application. Those tags are matched with sections of the program instruction set that provide that feature. Accordingly, at any point during development as that section of the instruction set is changed, the tag associated with the changed section is identified. With the tag known, and the mapping between tags and particular features stored in a database, the feature that is altered by the section change can be identified via the tag.

The method (100) described herein may be performed at any stage of development. That is, the detection (block 102) of changes and the association (block 103) of those changes with a particular application feature may include detecting (block 102) a new section of the application program instruction set and associating (block 103) that new section with a new feature. Accordingly, in this example, consumers may be made aware of to-be-released functions of a particular application.

In another example, the detection (block 102) of changes and the association (block 103) of those changes with a particular application feature may include detecting (block 102) a change to an existing section of the application program instruction set and associating (block 103) that changed section with an existing feature. Accordingly, in this example, consumers may be made aware of updates to an application they may already be using.

An overall example is now provided. In this example, an existing application may be a money management application with a particular feature that allows a user to view a graphical breakdown, for example in the form of a pie chart, of different categories that the user spends money on. During development, a developer may desire to expand this feature by not only indicating broad categories that the user spends money on, but to indicate sub-categories that the user spends money on, and how much. For example, rather than just indicating that a user spends 5% of monthly income on food, the developer would like to present to a user that they spend 1.5% of their monthly income on snack foods, 2.0% percent of their monthly income on dinner, and 1.5% of their monthly income on lunch. In so doing, the developer would change various sections of the application program instruction set to breakup raw data into the more detailed budgetary categories. The changes to the program instructions set may be detected (block 102), for example in a character-by-character fashion. Wherever a change is detected (block 103), the tag associated with that section is identified, and the features associated with that tag are also identified. Thus, the present method (100) is effective at not only identifying the changes made, but also in identifying the specific location within the program instruction set was changed.

Such a robust and comprehensive change tracking system provides a number of benefits. For example, maintenance and troubleshooting is more efficient. That is, rather than a developer having to de-bug the entire instruction set line-by-line, the developer may, using the tags, hone in on a particular section of the program instructions to identify the issue.

Moreover, such a system improves the functionality of the computing device itself on which it is executed. That is, when a problem occurs, rather than fixing the existing program instructions, the developer may include additional instructions to address the issue. Thus, multiple sections of the instruction set exist, one that contains the original instructions with its operating issue and the second section that includes redundant language, but without the instructions that cause the issue. In addition to possible complications later during execution, this approach also increases the overall length of the program instructions, in some cases providing conflicting instruction sections. Accordingly, by tagging the changes, a developer can avoid including redundant and bloated instructions, and can instead make any necessary changes to existing sections. Doing so reduces the overall length, and execution time, of the application. Thus, processing bandwidth is conserved and the computing device can execute the application and its features with a reduced load on the processor and reduces the bandwidth necessary to run the application thereby increasing processor performance.

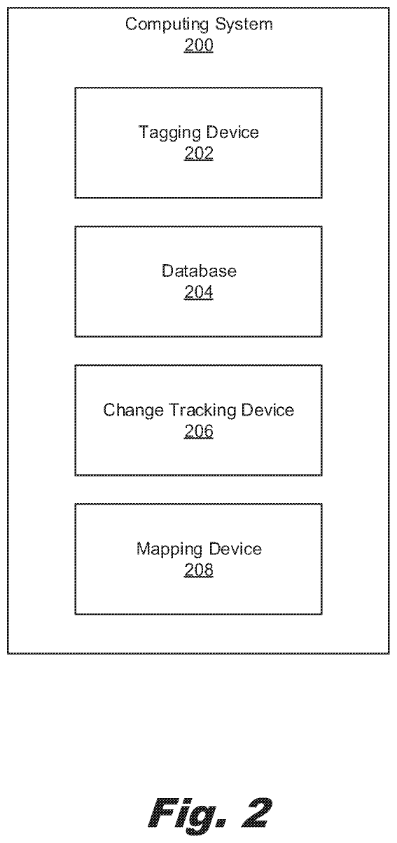

FIG. 2. depicts a computing system (200) for detecting application feature changes, according to an example of principles described herein. To achieve its desired functionality, the computing system (200) includes various components. Each component may include a combination of hardware and program instructions to perform a designated function. The components may be hardware. For example, the components may be implemented in the form of electronic circuitry (e.g., hardware). Each of the components may include a processor to execute the designated function of the component. Each of the components may include its own processor, but one processor may be used by all the components. For example, each of the components may include a processor and memory. Alternatively, one processor may execute the designated function of each of the components. In general, the computing system (200) may be disposed on any variety of computing devices. For example, the computing device may be on a desktop computer or on a laptop computer, or any other such device that includes processors and hardware components.

The computing system (200) includes a tagging device (202) to mark sections of an application program instruction set with tags to associate sections of the application program instruction set with different application features. As described above, using the tagging device (202), a user may select portions of the application program instruction set. The tagging device (202) may then generate a metadata tag for the selection. A user can name, create, or otherwise identify the tag in whatever form they desire.

The tags, and more specifically the mapping between tags and application features, are stored in a database (204). That is, the computing system (200) may include a physical memory device that has a database (204). The database (204) includes a mapping between tags and different application features. Accordingly, when it is determined that a section that relates to a particular tag has been changed, that change can be associated with the relevant application feature. Such tracking may be for record keeping purposes, development purposes, and to provide notice to a consumer.

The database (204) may store other pieces of information as well. For example, third parties may submit requests to be notified when changes to certain features are made. The third parties may be of any type. For example, in one case, the third-party is a quality assurance user of the application program instruction set. That is, before an application program instruction set is released to the public, it may be run by a quality assurance user. In this example, the quality assurance user may want to be aware of changes made to a particular feature that he/she knows is in development, such that when the change is recorded, he/she may go and test the feature to ensure its proper operation.

In another example, the third-party may be a consumes. That is, the consumer of the application may have a particular t st in a certain feature, i.e., the more detailed view of an expense report. Accordingly, the consumer may submit a request to be notified of developments of this feature. Accordingly, when changes are made to the relevant instruction set sections, these third parties are notified. In this example, the database (204) includes a mapping between the application features and the third-party subscribers that have requested to receive notifications of changes to particular application features. Accordingly, when a particular change is detected, and a particular application feature related to that change is identified, the computing system (200) can identify which individuals should be notified, via any mechanism such as instant message and/or email communication, of such a change.

In yet another example, the database (204) includes a mapping between application functionalities and application features. That is, the application functionality may refer to a particular offering of the application. For example, a financial application may have a functionality offering expense management tools. That functionality may include different features. For example, one feature may include the hierarchical display of information. In some examples, the third-party subscriber may select application functionalities, yet the sections of the program instructions may be tagged by feature. Accordingly, the database (204) may include a mapping between the application features, as represented by the tags, and the application functionalities as selected by the third-party subscribers. As described above, as a feature is a sub-component of a functionality, multiple application features may map to an application. feature. As noted herein, a subscriber may select individual features to be notified of, or may select functionalities to be notified of. In the latter example, the subscriber may be notified of any change to a feature associated with the selected functionality.

The computing system (200) may also include a change tracking device (206) to detect a change to a section of the application program instruction set. As described above, such a change tracking device (206) may take many forms. For example, the change tracking device (206) may analyze the program instructions before and after operation on a character-by-character basis.

In some examples, such a comparison may be performed periodically or may be initiated based on user input. For example, as a user saves a file with the program instructions, the change tracking device (206) may be activated. In another example, the user selects an icon or otherwise activates the change tracking device (206) independent of a save function. In yet another example, the change tracking device (206) may be activated independent of any user action. That is, the change tracking device (206) may be initiated periodically at predetermined interval, each day for example, to detect when changes have been made to a particular feature. This may be helpful as a developer does not have to manually perform another step, but can have such information automatedly distributed to subscribed parties. While particular reference is made to one form of change tracking device (206), i.e., a character-by-character comparison, other forms of change tracking may be performed such as version comparisons.

The computing system (200) also includes a mapping device (208) to associate, based on the database (204), the change to the section of the application program instruction set with a change to a respective application feature, and in some cases to associate the change to the section of the application program instruction set to an application functionality that includes the feature. That is, once a change to the actual program instruction set is detected, and an associated tag identified, the mapping device (208) may consult the database (204) to identify the feature and/or functionality associated with that tag.

As a specific example, a developer may add a login function to an application by updating the program instruction set and creating a tag for that section of the program instruction set. Following the detection of the change, the tag associated with this login feature is identified. The mapping device (208) then associates this tag with the feature of “application access.” As described above, third parties that have subscribed to receive notifications of changes to an application access functionality, or a quality assurance user who tests these features, may then be properly notified of the change. Thus, the system provides a systematic way of disseminating information relating to changes of program instructions to a wide variety of people such that those individuals may be aware of the changes and if needed, take appropriate action. As described above, such information dissemination and notification can enhance development transparency to the delight of consumers and to make the development process more effective and efficient.

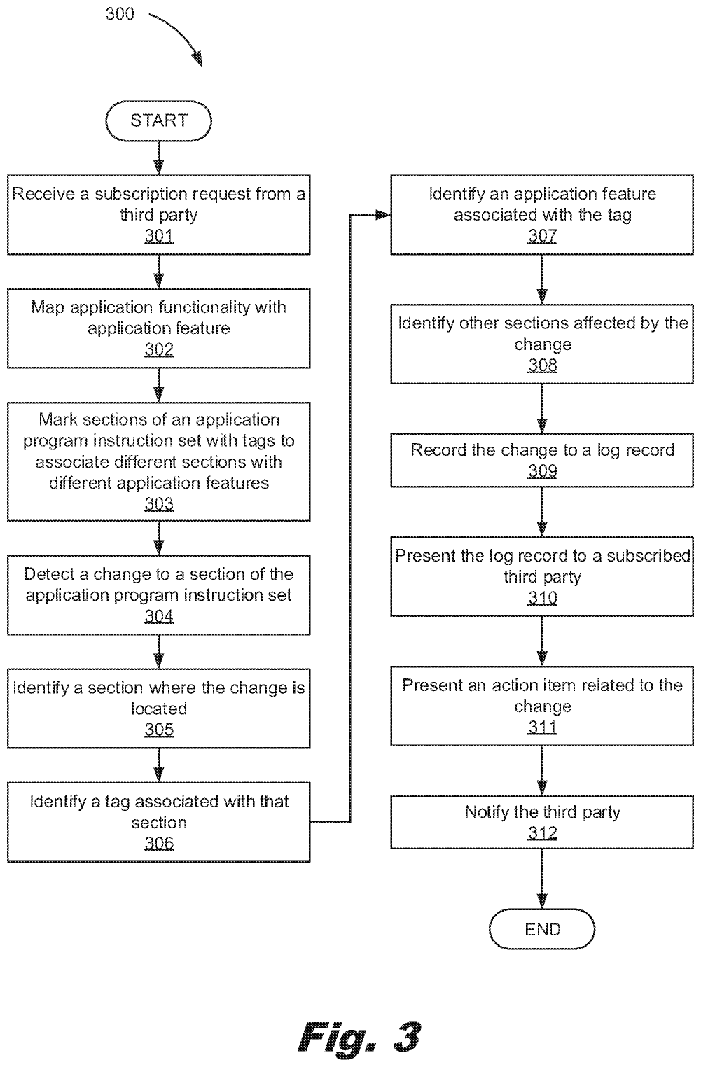

FIG. 3 depicts a flowchart of the method (300) for detecting application feature changes, according to another example of principles described herein. According to the method (300), the computing system (FIG. 2, 200) receives (block 301), from a third-party, a subscription request to receive notifications of changes to particular application features. As described above, in some cases such a subscription request identifies an application functionality, as opposed to the feature, for which the third-party iso receive notifications. In this case, the application functionality selected by the third-party is mapped (block 302) to the application features that relate to that functionality. For example, in a shipping logistics application, a particular consumer, in this case a shipping company or a product manufacturer, may be interested in a system security functionality. Accordingly, the shipping company may submit a request to be notified of changes related to the system security functionality, in this example, the feature being developed may relate to a login procedure. Accordingly, the computing system (FIG. 2, 200) receives (block 301) the subscription request for “system security” and maps (block 302) this functionality to at least the feature of the login. procedure. As described above, the system security functionality may also be mapped to other features, such as a logout procedure, or any other authentication procedures.

Then, during development or at some other point in time, sections of the application program instruction set are marked (block 303) with tags to associate them with different features and as changes are made to the different sections, these changes are detected (block 304). These operations may be performed as described above in connection with FIG. 1.

Once a change is detected, any number of operations are carried out to associate the change with the feature that pertains to that section. Accordingly, a section within the application program instruction set where the change is occurred is identified (block 305). As described above, this may be done via a character-by-character comparison by the change tracking device (FIG. 2, 206) of different versions of the program instructions. The tag associated with that section is then identified (block 306). That is, once a section is identified as having a changed text, the associated tag is retrieved. The application feature associated with that tag is then identified (block 307). That is, the mapping device (FIG. 2, 208) may consult the mapping in the database (FIG. 2, 204) to identify what application feature relates to the section where the change was made.

In some examples, other sections that are affected by the change are also identified (block 308). That is, it may be the case that a change to one feature may impact another feature. For example, a change to a login feature of an application may affect how another type of authentication, for example, biometric authentication, operates. Accordingly, using the tags described above, other sections/features that may be affected by the change are also identified.

In some examples, the changes to a program instruction set are recorded (block 309) in a log record. The log record may be organized in any fashion. Specifically, the log record may be per-application and changes to any functionality may be stored therein. In another example, the log record may be per-feature or per-functionality such that just those changes related to a particular functionality and/or feature are stored. This log record can then be presented (block 310) to third parties who have subscribed to receive notifications related to changes to the corresponding sections of the application program instruction set. The log record may provide various pieces of information to the subscribed third-party. Such a notification may simply provide an awareness of feature/functionality development, or may trigger action on that third-party. For example, a quality assurance user may use information contained in the log record to determine that a test of certain features is in order. By comparison, a consumer may simply be able to see the status, development, and/or timeline of a to-be-released functionality in which they have particular interest.

In some cases, an action item related to the change may be presented (block 311). For example, once a change has been made, the action item may notify a quality assurance technician that a test of the feature is ready to be carried out. While particular reference is made to one action item, a variety of action items may be presented (block 311) related to the change.

Once the change has been detected (block 304) and associated with the relevant application feature, the subscribed third parties may be notified (block 312). Such notification may come in a variety of forms. For example, a user may be notified via message to their computing device, an email message, or a text message. Thus, the present method (300) describes not only the identification of changes to an application, but indicate where in the instruction set the change occurs, and also notifies interested parties to the changes that were made.

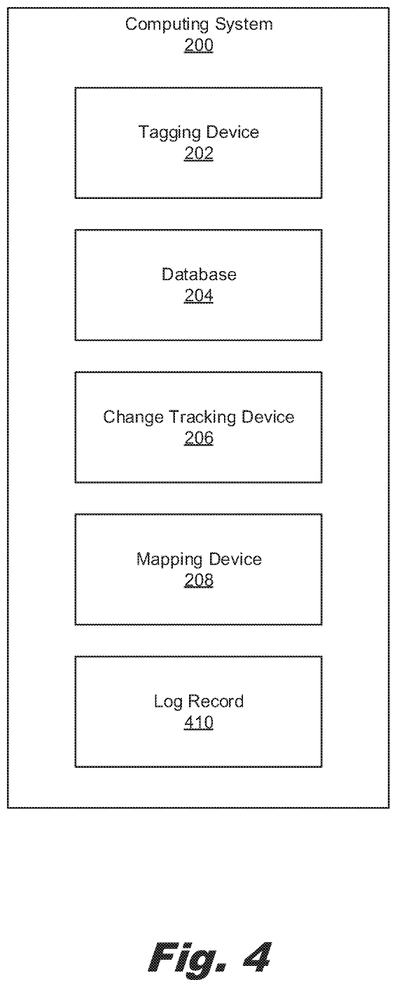

FIG. 4 depicts a computing system (200) for detecting application feature changes, according to another example of principles described herein. In the example depicted in FIG. 4, the computing system (200) includes the tagging device (202), database (204), change tracking device (206), and mapping device (208) as described above in connection with FIG. 2. in some examples, the computing system (200) includes additional components. For example, the computing system (200) includes a log record (410) that includes a record of changes to an application feature. The log record (410) may be unique to an application feature. In other examples, the log record (410) includes all changes made to an application functionality, which may include changes to multiple application features. In yet another example, the log record (410) includes all changes made to an application, which may include changes to multiple application features and functionalities.

The log record (410) may store various pieces of information. For example, each entry in the log record (410) may include a tag associated with the application feature that was changed. The log record (410) entry may also indicate the current version of the application feature as well as any number of past versions of the application feature. Even further, the log record (410) may store a date of the last change to the application feature. As described above, this information may be recorded and, in some cases, presented to a subscribed third-party such that they can see a status and progress of a current application feature.

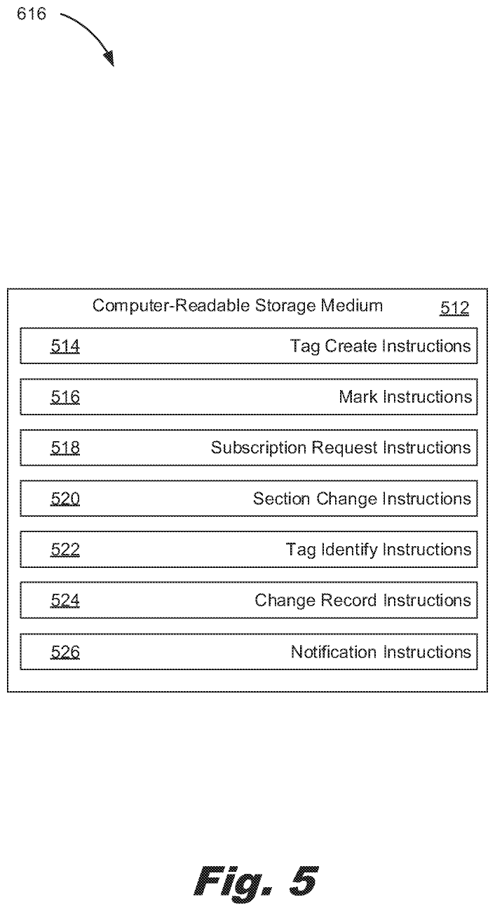

FIG. 5 depicts a computer program product with a computer readable storage medium (512) for detecting application feature changes, according to an example of principles described herein. To achieve its desired feature, a computing system includes various hardware components. Specifically, a computing system includes a processor and a computer-readable storage medium (512). The computer-readable storage medium (512) is communicatively coupled to the processor. The computer-readable storage medium (512) includes a number of instructions (514, 516, 518, 520, 522, 524, 526) for performing a designated function. The computer-readable storage medium (512) causes the processor to execute the designated function of the instructions (514, 516, 518, 520, 522, 524, 526).

Referring to FIG. 5, tag create instructions (514), when executed by the processor, cause the processor to create tags related to different application features of an application program instruction set. Mark instructions (516), when executed by the processor, may cause the processor to mark sections of an application program instruction set with tags to associate different sections of the application program instruction set with different application features. Subscription request instructions (518), when executed by the processor, may cause the processor to receive a subscription request from the third-party to receive notification of changes to a particular application feature, Section change instructions (520), when executed by the processor, may cause the processor to detect a change to a section of the application program instruction set associated with the particular application feature. Tag identify instructions (522), when executed by the processor, may cause the processor to identify the tag associated with a changed section of the application program instruction set, Change record instructions (524), when executed by the processor, may cause the processor to record a change to the particular application feature associated with the tag. Notification instructions (526), when executed by the processor, may cause the processor to provide notification to the third-party that the particular application feature is changed,

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor of the computing system or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
marking sections of an application program instruction set with tags to associate the sections of the application program instruction set with different application features;
mapping different application features to an application functionality, wherein an application functionality comprises multiple application features;
detecting a change to a section of the application program instruction set;
associating, based on a tag, the change to the section of the application program instruction set with a change to a respective application feature; and
associating, based on a mapping between different application features to an application functionality, the change to the section of the application program instruction set with a change to a respective application functionality.

2. The computer-implemented method of claim 1, further comprising notifying a third-party of the change to the respective application feature.

3. The computer-implemented method of claim 2, further comprising receiving, from the third-party, a subscription request to receive notifications of changes to particular application features.

4. The computer-implemented method of claim 3, wherein the subscription request identifies an application functionality for which the third-party is to receive notifications.

5. (canceled)

6. The computer-implemented method of claim 1, wherein associating, based on a tag, the change to the section of the application program instruction set with a change to a respective application feature comprises:
identifying the section within the application program instruction set where the change is located;
identifying the tag associated with that section; and
identifying the application feature associated with the tag.

7. The computer-implemented method of claim 1, further comprising identifying other sections of the application program instruction set affected by the change.

8. The computer-implemented method of claim 1, further comprising:
recording the change to the section of the application program instruction set to a log record; and
presenting the log record to a third-party who has subscribed to receive notifications related to changes to the section of the application program instruction set.

9. The computer-implemented method of claim 1, further comprising presenting an action item related to the change to the section to the application program instruction set.

10. A computing system, comprising:
a tagging device to mark sections of an application program instruction set with tags to associate sections of the application program instruction set with different application features;
a database to:
map tags to application features; and
map application features to application functionalities selected by third-party subscribers, wherein an application functionality comprises multiple application features;
a change tracking device to detect a change to a section of the application program instruction set; and
a mapping device to:
associate, based on the database, the change to the section of the application program instruction set with a change to a respective application feature; and
associate, based on the database, the change to the section of the application program instruction set with a change to an application functionality that comprises the respective application feature.

11. The computing system of claim 10, wherein the database comprises a mapping between application features and third-party subscribers that have requested to receive notifications of changes to particular application features.

12. (canceled)

13. The computing system of claim 10, wherein multiple application features map to an application functionality.

14. The computing system of claim 10, further comprising a log record of changes, wherein entries into the log record indicates at least one of:
the tag associated with application feature;
a current version of the application feature;
a past version of the application feature; and
a date of the change to the application feature.

15. A computer program product, the computer program product comprising a computer readable storage medium having program instructions embodied therewith, the program instructions executable by a processor to cause the processor to:
via machine-learning create tags related to different application features of an application program instruction set by:
identifying an application feature related to a section of the application program instruction set;
generating a tag; and
marking sections of the application program instruction set with tags to associate sections of the application program instruction set with different application features;
map different application features to an application functionality, wherein an application functionality comprises multiple application features;
receive, from a third-party, a subscription request to receive notifications of changes to a particular application functionality;
detect, at predetermined intervals, a change to a section of the application program instruction set associated with the particular application feature by performing a textual-based analysis of the application program instruction set before and after an operation;
identify the tag associated with a changed section of the application program instruction set;
identify the application functionality associated with the changed section of the application program instruction set;
record a change to the particular application feature associated with the tag; and
provide notification to the third-party that the particular application functionality is changed.

16. The computer program product of claim 15, wherein the third-party is a quality insurance user of the application program instruction set.

17. The computer program product of claim 15, wherein the third-party is a consumer of the application program instruction set.

18. The computer program product of claim 15, wherein the tag is associated with multiple sections of the application program instruction set.

19. The computer program product of claim 15, wherein detecting a change to a section of the application program instruction set associated with the particular application feature comprises detecting a new section of the application program instruction set.

20. The computer program product of claim 15, wherein detecting a change to a section of the application program instruction set associated with the particular application feature comprises detecting a change to an existing section of the application program instruction set.

21. The computer-implemented method of claim 2, wherein notifying a third-party of the change to the respective application feature comprises providing the third-party with a prompt to take action.

22. The computer-implemented method of claim 2, wherein notifying a third-party of the change to the respective application feature comprises providing the third-party with an indication where in the application program instruction set the change occurred.
